(19) United States
(12) Patent Application Publication
(10) Pub. No.: US 2010/0287329 A1
(43) Pub. Date: Nov. 11, 2010

(54) Partial Page Operations for Non-Volatile Memory Systems

(75) Inventors: Tahoma Toelkes, San Jose, CA (US); Daniel Jeffrey Post, Campbell, CA (US); Nir Jacob Wakrat, Los Altos, CA (US)

Correspondence Address: FISH & RICHARDSON P.C., PO BOX 1022, MINNEAPOLIS, MN, 55440-1022, US

(73) Assignee: Apple Inc., Cupertino, CA (US)

(21) Appl. No.: 12/536,410

(22) Filed: Aug. 5, 2009

Related U.S. Application Data
(60) Provisional application No. 61/176,087, filed on May 6, 2009.

(51) Int. Cl. G06F 12/00; G06F 12/02

(52) U.S. Cl. 711/103; 711/E12.001; 711/E12.008

(57) ABSTRACT

A read command initiates reads of pages or portions of pages of non-volatile memory using a memory address that specifies a row, column and length. A host controller can use the read command with a read operation or status request. In some implementations, the memory address further specifies a die or plane and a block.

### RELATED APPLICATION

This application claims the benefit of priority from U.S. Provisional Patent Application No. 61/176,087 filed May 6, 2009, which is incorporated by reference herein in its entirety.

### TECHNICAL FIELD

This subject matter is related generally to access and management of managed non-volatile memory (NVM).

### BACKGROUND

Flash memory is a type of electrically erasable programmable read-only memory (EEPROM). Because flash memories are non-volatile and relatively dense, they are used to store files and other persistent objects in handheld computers, mobile phones, digital cameras, portable music players, and many other devices in which other storage solutions (e.g., magnetic disks) are inappropriate.

NAND is a type of flash memory that can be accessed like a block device, such as a hard disk or memory card. Each block consists of a number of pages (e.g., 64-128 pages). A typical page size is 4 KB-8 KB bytes. A NAND device can have multiple dies each having 4096-8192 blocks. Associated with each page are a number of bytes that are used for storage of error detection and correction checksums. Reading and programming is performed on a page basis, erasure is performed on a block basis, and data in a block can only be written sequentially. NAND relies on Error Correction Code (ECC) to compensate for bits that may flip during normal device operation. When performing erase or program operations, the NAND device can detect blocks that fail to program or erase and mark the blocks as bad in a bad block map. The data can be written to a different, good block, and the bad block map updated.

Managed NAND devices combine raw NAND with a memory controller to handle error correction and detection, as well as memory management functions of NAND memory. Managed NAND is commercially available in Ball Grid Array (BGA) packages, or other Integrated Circuit (IC) package which supports standardized processor interfaces, such as Multimedia Memory Card (MMC) and Secure Digital (SD) card. A managed NAND device can include a number of NAND devices or dies, which can be accessed using one or more chip select signals. A chip select is a control line used in digital electronics to select one chip out of several chips connected to the same bus. The chip select is typically a command pin on most IC packages, which connects the input pins on the device to the internal circuitry of that device. When the chip select pin is held in the inactive state, the chip or device ignores changes in the state of its input pins. When the chip select pin is held in the active state, the chip or device responds as if it is the only chip on the bus.

The Open NAND Flash Interface Working Group (ONFI) has developed a standardized low-level interface for NAND flash chips to allow interoperability between conforming NAND devices from different vendors. ONFI specification version 1.0 specifies: a standard physical interface (pin-out) for NAND flash in TSOP-48, WSOP-48, LGA-52, and BGA-63 packages; a standard command set for reading, writing, and erasing NAND flash chips; and a mechanism for self-identification. ONFI specification version 2.0 supports dual channel interfaces, with odd chip selects (also referred to as chip enable or “CE”) connected to channel 1 and even CEs connected to channel 2. The physical interface shall have no more than 8 CEs for the entire package.

While the ONFI specifications allow interoperability, the current ONFI specifications do not take full advantage of managed NAND solutions.

### SUMMARY

A read command initiates reads of pages or portions of pages of non-volatile memory using a memory address that specifies a row, column and length. A host controller can use the read command with a read operation or status request. In some implementations, the memory address further specifies a die or plane and a block.

In some implementations, a method comprises: transmitting a partial page read command to a non-volatile memory device, the partial page read command specifying a subset of a page of non-volatile memory; and receiving data retrieved by the non-volatile memory device from the specified subset of the page in response to the partial page read command.

In some implementations, a method comprises: transmitting a status request command to a non-volatile memory device, the status request command specifying a subset of a page of non-volatile memory; and responsive to the status request command, receiving status data from the non-volatile memory device, the status data associated with the specified subset of the page.

Other implementations are disclosed related to apparatuses, systems, methods and computer-readable mediums.

### BRIEF DESCRIPTION OF THE DRAWINGS

FIG. 1 is a block diagram of an exemplary memory system including a host processor coupled to a managed NVM package.

FIG. 2 illustrates an exemplary address mapping for the managed NVM package of FIG. 1.

FIG. 3 illustrates the address mapping of FIG. 2 including bad block replacement.

FIG. 4 illustrates a memory access using a row, column and length address.

FIG. 5A is an exemplary multipage read timing diagram for a full page read.

FIG. 5B is an exemplary multipage read timing diagram for a partial page read.

FIG. 6 is a flow diagram of an exemplary process for accessing NVM using a partial page read operation.

### DETAILED DESCRIPTION

### Memory System Overview

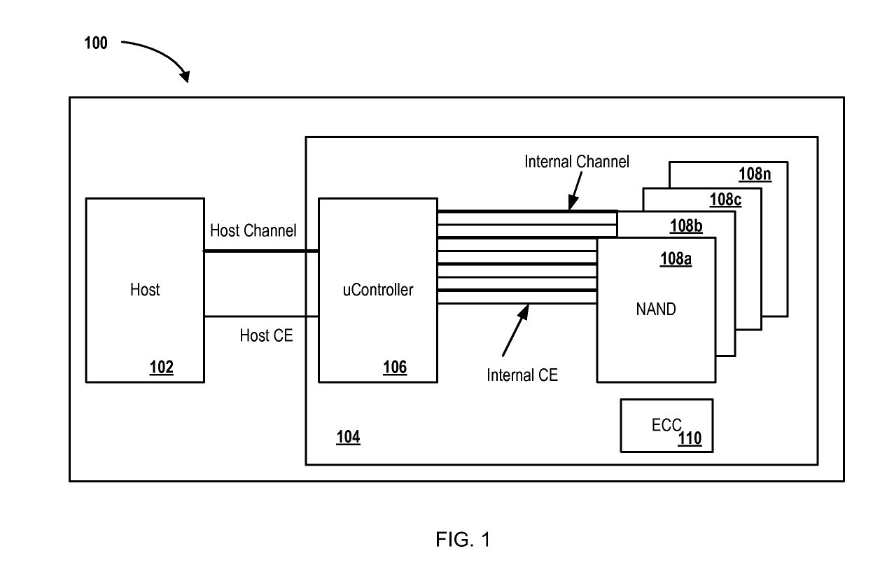

FIG. 1 is a block diagram of an exemplary memory system 100 including a host controller 102 coupled to a managed NVM package 104 (e.g., a NAND device). The NVM package 104 can be a BGA package or other IC package, including multiple NVM devices 108 (e.g., multiple raw NAND dies). The memory system 100 can be used in a variety of devices, including but not limited to: handheld computers, mobile phones, digital cameras, portable music players, toys, thumb drives, email devices, and any other devices in which non-volatile memory is desired or required. As used herein, raw NVM is a memory device or package which is managed by an external host processor, and managed NVM is a memory device or package that includes at least one internal memory management function, such as error correction, wear leveling, bad block management, etc.

In some implementations, the NVM package 104 can include a controller 106 for accessing and managing the NVM devices 108 over internal channels using internal chip select signals. An internal channel is a data path between the controller 106 and a NVM device 108. The controller 106 can perform memory management functions (e.g., wear leveling, bad block management) and can include an error correction (ECC) engine 110 for detecting and correcting data errors (e.g., flipped bits). In some implementations, the ECC engine 110 can be implemented as a hardware component in the controller 106 or as a software component executed by the controller 106. In some implementations, the ECC engine 110 can be located in the NVM devices 108.

In some implementations, the host controller 102 and NVM package 104 can communicate information (e.g., control commands, addresses, data) over a communication channel visible to the host (“host channel”). The host channel can support standard interfaces, such as raw NAND interfaces or dual channel interfaces, such as is described in ONFI specification version 2.0. The host controller 102 can also provide a host chip enable (CE) signal. The host CE is visible to the host controller 102 to select the host channel.

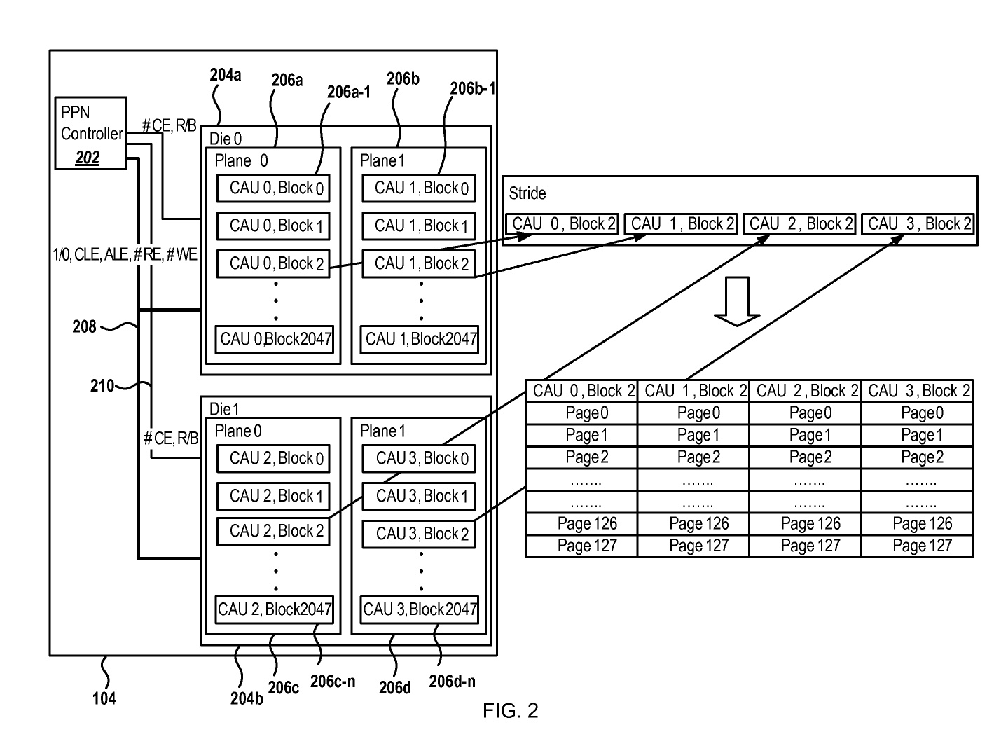

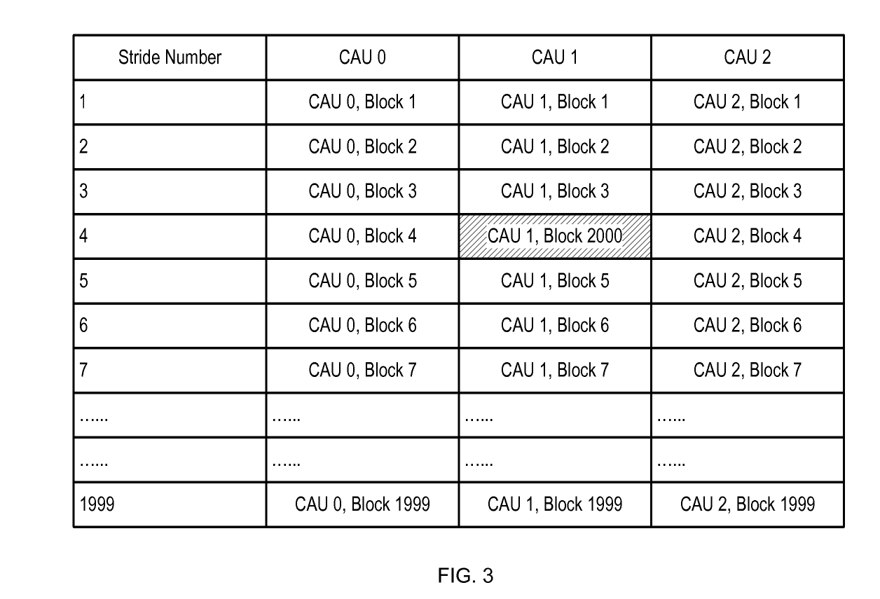

In the exemplary memory system 100, the NVM package 104 supports CE hiding. CE hiding allows the single host CE to be used for each internal channel in the NVM package 104, thus reducing the number of signals required to support the interface of the NVM package 104. Memory accesses can be mapped to internal channels and the NVM devices 108 using an address space and mapping scheme, as described in reference to FIGS. 2 and 3. Individual NVM devices 108 can be enabled using internal CE signals generated by the controller 106.

### Exemplary Address Mapping

FIG. 2 illustrates an exemplary mapping scheme for the managed NVM package 104 of FIG. 1. In particular, the mapping can be used with managed NAND devices that include multiple dies, where each die can potentially include multiple planes. In some implementations, the address mapping operates on Concurrently Addressable Units (CAUs). A CAU is a portion of physical storage accessible from a single host channel that may be read, programmed or erased simultaneously to, or in parallel with other CAUs in the NVM package. A CAU can be, for example, a single plane or a single die. A CAU size is the number of erasable blocks in a CAU.

The address mapping will now be described with respect to the exemplary memory architecture of FIG. 2. For this exemplary architecture, a block size is defined as a number of pages in an erasable block. In some implementations, 16 bytes of metadata are available for each 4 kilobytes of data. Other memory architectures are also possible. For example, the metadata can be allocated more or fewer bytes.

The address mapping shown in FIG. 2 allows the use of raw NAND protocol to read/program/erase NAND blocks and additional commands that enable optimized performance. The NVM package 104 includes an ECC engine (e.g., ECC engine 110) for managing data reliability of the NAND. Thus, the host controller 102 does not need to include an ECC engine 110 or otherwise process data for reliability purposes.

The NVM package 104 defines a CAU as an area that can be accessed (e.g., moving data from the NAND memory cells to an internal register) simultaneous to, or in parallel with other CAUs. In this exemplary architecture, it is assumed that all CAUs include the same number of blocks. In other implementations, CAUs can have a different numbers of blocks. Table I below describes an exemplary row address format for accessing a page in a CAU.

TABLE I
Exemplary Row Address Format

| R[X + Y:X + Z − 1] | R[X:X + Y − 1] | R[0:X − 1] |
|---|---|---|
| CAU | Block | Page |

Referring to Table I, an exemplary n-bit (e.g., 24 bits) row address can be presented to a controller in the NAND device in the following format: [CAU: Block: Page]. CAU is a number (e.g., an integer) that represents a die or plane. Block is a block offset in the CAU identified by the CAU number, and Page is a page offset in the block identified by Block. For example, in a device with 128 pages per block, 8192 blocks per CAU and 6 CAUs: X will be 7 (27=128), Y will be 13 (213=8192) and Z will be 3 (22<6<23).

The exemplary NVM package 104 shown in FIG. 2 includes two NAND dies 204a, 204b, and each die has two planes. For example, die 204a includes planes 206a, 206b. And, die 204b includes planes 206c, 206d. In this example, each plane is a CAU and each CAU has 2048 multi-level cell (MLC) blocks with 128 pages per block. Program and erase operations can be performed on a stride of blocks (a block from each CAU). A stride is defined as an array of blocks each coming from a different CAU. In the example shown, a “stride 0” defines a block 0 from each of CAUs 0-3, a “stride 1” defines a block 1 from each of CAUs 0-3, a “stride 2” defines a block 2 from each of CAUs 0-3 and so forth.

The NVM package includes an NVM controller 202, which communicates with the CAUs through control bus 208 and address/data bus 210. During operation, the NVM controller 202 receives commands from the host controller (not shown) and in response to the command asserts control signals on the control bus 208 and addresses or data on the address/data bus 210 to perform an operation (e.g., read, program, or erase operation) on one or more CAUs. In some implementations, the command includes a row address having the form [CAU: Block: Page], as described in reference to FIG. 2.

FIG. 3 illustrates the address mapping of FIG. 2 including bad block replacement. In this example, a stride address is issued by the host controller 102 for NVM package 104, which includes three CAUs. One of the CAUs holds a bad block in the stride block offset. A “stride 4” address would normally access CAU0: Block4, CAU1: Block4 and CAU2: Block4. In this example, however, the bad block CAU1: Block4 is replaced by CAU1: Block2000.

### Exemplary Read Operations For Partial Pages of NVM

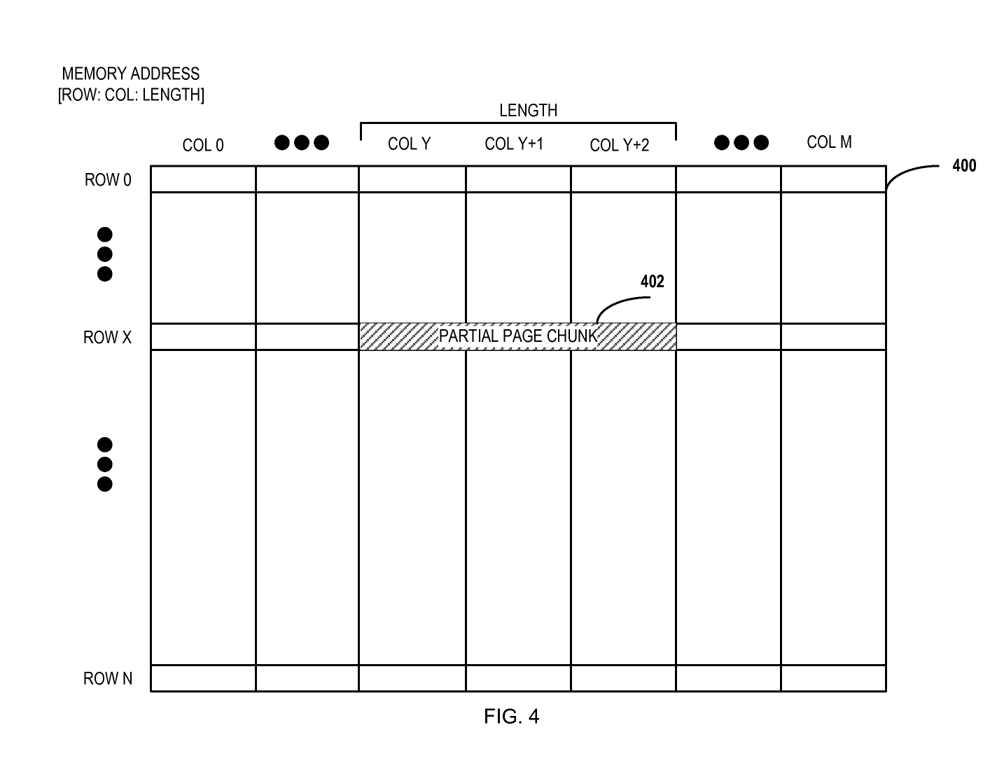

FIG. 4 illustrates a memory access using a row, column and length address. Conventional memory addresses include a row and column. A read command results in the entire row being read starting from the column address. By contrast, a partial page address includes an additional length parameter, which is used together with the row and column addresses to select a partial page chunk of data.

In the example shown in FIG. 4, a memory address [Row: Column: Length] is used to select a portion 402 of a page in a NVM array 400. Row specifies a row in the memory array 400 (e.g., a page address), Column specifies a starting address in the Row for the read operation (e.g., an offset into the page specified by Row) and Length specifies a number of bytes to be read starting from the address specified by Column.

In an implementation that uses CAUs, the memory address can be [CAU: Block: Page: Col: Length], where CAU determines a die or plane containing the data to be read, Block identifies a block in the CAU containing the data to be read, Page specifies a page in the block containing the data to be read, Col specifies an offset into the Page where the data to be read is stored and Length specifies a number of bytes of the data to be read.

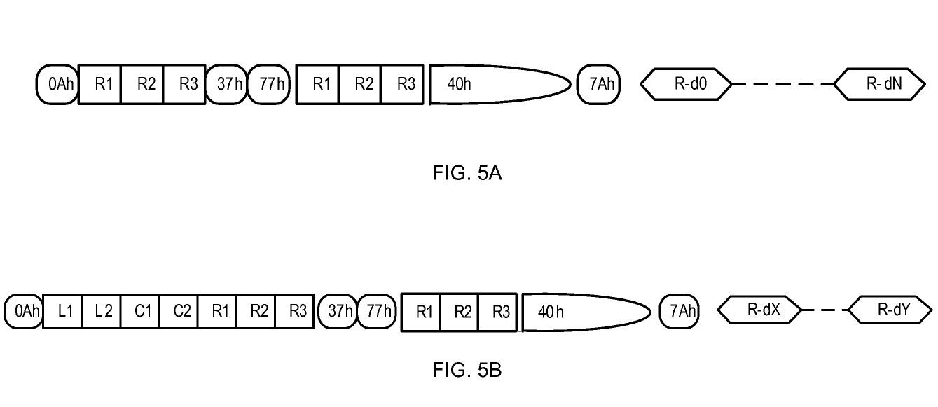

FIG. 5A is an exemplary multipage read timing diagram for a full page read. A multipage read command includes the codes 0Ah and 37h. However, any desired codes can be used. The 0Ah code precedes a row address indicating the first page of the multipage read operation. In this example, the row address is specified by three bytes R1, R2, R3. Any desired number of bytes, however, can be used to specify a row address. In a CAU based system where a row address is specified by [CAU, Block, Page], R1 can represent CAU, R2 can represent Block and R3 can represent Page.

Following the row address is the code 37h, which is a command that commits the read operation by the device. The 37H code is followed by the code 77h, which indicates the beginning of a read operation status command. Following the code 77h is the row address for which the status is to be performed on, represented by bytes R1, R2, R3. The row address is followed by the code 40h, which is a mask value that is being waited for on the bus by the host controller to indicate that the remaining bits of the status byte being read are valid and that the operation is complete, allowing progress to continue and the final portion of the operation, the actual data transfer, to commence. Following the code 40h is the actual reading of data from memory which is represented by R-d0 . . . R-dN, where N is the number of pages to be read starting from the page address specified by R1, R2, R3 in the multipage read operation.

FIG. 5B is an exemplary multipage read timing diagram for a partial page read. A multipage read command includes the codes 0Ah and 37h. However, any desired codes can be used. Following the code 0Ah, there are 7 bytes of data represented by L1, L2, C1, C2, R1, R2, R3. L1 and L2 are bytes representing a Length parameter. The Length parameter is a number of bytes to be read starting from a column address specified by bytes C1, C2. C1, C2 represent an offset into a page specified by the row address R1, R2, R3. The 7 bytes are followed by the code 37h indicating the end of the multipage read command. The code 77h indicates a read operation status command and is followed by the row address of the first page to be read in the multipage read operation. The code 77h is followed by the row address R1, R2, R3 and code 40h. The code 40h (described above) is followed by the code 7Ah. Following the code 7Ah are the pages to be read which is indicated by R-dX−R-dY. X is Column (described by C1, C2), Y is the sum of Column and Length (described by L1, L2) minus 1.

### Exemplary Process For Partial Page Read

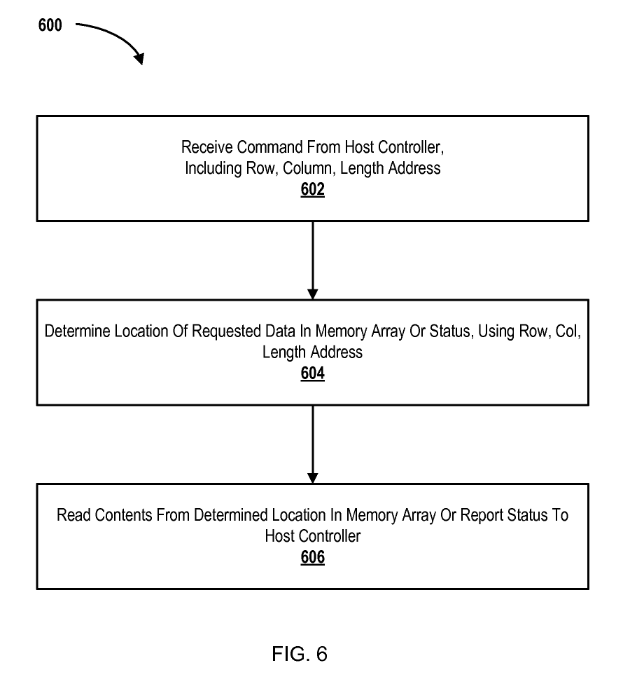

FIG. 6 is a flow diagram of an exemplary process 600 for accessing NVM using a partial page read operation. In some implementations, the process 600 begins when a command is received from a host controller, including an [Row:Column:Length] address (602). In a CAU based memory system, Row can have the row address format of [CAU: Block: Page], as described in reference to FIG. 2. The command can be a read command, a status command or any other desired command. The memory address is used to determine the location of the requested data to be read or to determine a status of an operation (604). Data is read from the determined location in a memory array or a status is reported back to the host controller (606).

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments have been described. Other embodiments are within the scope of the following claims.

What is claimed is:

1. A computer-implemented method comprising:
receiving a read command, the read command including a memory address specifying a row, column and length;
determining a location in a non-volatile memory array based on the memory address; and
reading contents from the determined location of the non-volatile memory array.

2. The method of claim 1, where the read command initiates a multi-page read operation.

3. The method of claim 1, where row specifies a row in the non-volatile memory array, column specifies a starting address in the row for the read operation and length specifies a number of bytes to be read starting from the memory address specified by column.

4. The method of claim 1, where reading contents from a determined location includes reading a determined location of a page of the non-volatile memory.

5. The method of claim 1, where the memory address further specifies a die or plane of non-volatile memory and a block in the die or plane, where the row specifies a page in the block, the column specifies an offset into the page and the length specifies a number of bytes of data to be read starting at the offset of the page.

6. A non-volatile memory package comprising:
an interface configured for receiving a read command, the read command including a memory address specifying a row, column and length; and
a controller coupled to the interface and configured for determining a location in a non-volatile memory array based on the memory address, and for reading contents from the determined location of the non-volatile memory array.

7. The package of claim 6, where the read command initiates a multi-page read operation.

8. A computer-implemented method comprising:
receiving a status request command, the status request command including a memory address specifying a row, column and length;
determining a status based on the memory address; and
reporting the status to a host controller.

9. The method of claim 8, where the status request command is associated with a multi-page read operation.

10. A non-volatile memory package comprising:
an interface configured for receiving a status request command, the status request command including a memory address specifying a row, column and length; and
a controller coupled to the interface and configured for determining a status based on the memory address, and for reporting the status to a host controller.

11. The package of claim 10, where the status request command is associated with a multi-page read operation.

12. A method comprising:
receiving a read command specifying a row, column and length associated with a portion of a page of non-volatile memory; and
responsive to the read command, reading data from the specified portion of the page of non-volatile memory.

13. The method of claim 12, where the read command is a multi-page read operation, and data is read from specified portions of at least two pages of non-volatile memory.

14. A method comprising:
transmitting a partial page read command to a non-volatile memory device, the partial page read command specifying a subset of a page of non-volatile memory; and
receiving data retrieved by the non-volatile memory device from the specified subset of the page in response to the partial page read command.

15. The method of claim 14, where the read command is a multi-page read operation.

16. The method of claim 14, where the partial page read command includes a memory address that specifies a die or plane of non-volatile memory, a block in the die or plane, a page in the block, an offset into the page and a number of bytes of data to be read starting at the offset of the page.

17. A method comprising:
transmitting a status request command to a non-volatile memory device, the status request command specifying a subset of a page of non-volatile memory; and
responsive to the status request command, receiving status data from the non-volatile memory device, the status data associated with the specified subset of the page.
